(19) United States
(12) Patent Application Publication
(10) Pub. No.: US 2003/0171906 A1
(43) Pub. Date: Sep. 11, 2003

(54) Method for transforming stand-alone verification tests for an embedded block into serial scan test patterns for detecting manufacturing defects

(76) Inventors: Ishwardutt Parulkar, San Francisco, CA (US); Amitava Majumdar, San Jose, CA (US); Rajesh Pendurkar, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/094,885

(22) Filed: Mar. 11, 2002

(51) Int. Cl. G06F 17/50

(52) U.S. Cl. 703/14

(57) ABSTRACT

A method of transforming a stand-alone verification test for a functional block into a serial scan test pattern for detecting manufacturing defects includes designing a functional block based on a set of design considerations; generating a parallel functional pattern for testing the functional block; and translating the parallel functional pattern into a serial pattern. An apparatus for transforming a stand-alone verification test for a functional block into a serial scan test pattern for detecting manufacturing defects, comprising a functional block designed based on a set of design considerations and comprising a scan boundary, the scan boundary comprising a scan in chain and a scan out chain, a parallel functional pattern for testing the functional block; and software for translating the parallel functional pattern into a serial pattern that is fed into the scan in chain, evaluated, and fed out of the scan out chain.

### BACKGROUND OF INVENTION

The primary objectives of testing integrated circuits (ICs) are preventing faulty circuits from being assembled into equipment and detecting, in assembled equipment, circuits that have developed faults. Faults may develop during manufacturing, assembly, or other processes. There are three main aspects of integrated circuit testing: fault detection, physical fault location, and component fault location. Fault detection relates to discovering faulty elements in a circuit or system. Physical fault detection involves locating the source of a fault within an integrated circuit. Lastly, component fault location involves locating a faulty component or connection within an assembled system.

In general, the behavior of ICs may be characterized by discrete responses to discrete input signals. Generally, circuits may be tested by analyzing the behavior of the circuit under numerous operating modes and with different patterns of input signals. However, most integrated circuits are too complex to be tested in this manner. Thus, test methods have been developed to test the circuits using a fraction of all possible test conditions without sacrificing fault coverage. Fault coverage is a measure of the quality of the test procedure. It is a ratio of the number of faults that the test can detect to the total number of possible faults.

There are various test design strategies, known as design-for-testability (DFT) techniques, for ensuring high fault coverage in IC testing. In DFT, test patterns may be generated using an automatic test pattern generation (ATPG) algorithm to be applied via chip pins or scan mechanism; or dedicated test circuitry may be designed to generate and apply test patterns inside the chip by using built-in self-test (BIST) logic. The goal of these DFT strategies is to target manufacturing defects and ensure a high fault coverage. However, there are a class of designs for which either the above DFT techniques are not applicable or, if applicable, the DFT techniques do not guarantee high fault coverage. Examples of such areas on the chip are blocks with partial scan, sequential multi-cycle paths, small arrays and register files that do not fall under the scope of BIST, memory shadow logic, and special circuits, e.g., scoreboards in microprocessors and the like.

In the past, techniques such as hand-crafted test patterns applied at the chip level and fault simulation of functional patterns at the chip level were used to ensure high fault coverage in these types of blocks. As the complexity of chips increases though, the ability to hand-crafting test patterns becomes less feasible.

### SUMMARY OF THE INVENTION

In general, in accordance with one or more embodiments, the present invention involves a method of transforming a stand-alone verification test for a functional block into a serial scan test pattern for detecting manufacturing defects, comprising designing a functional block based on a set of design considerations; generating a parallel functional pattern for testing the functional block; and translating the parallel functional pattern into a serial pattern.

In general, in accordance with one or more embodiments, the present invention involves a method of transforming a stand-alone verification test for a functional block into a serial scan test pattern for detecting manufacturing defects, comprising designing a functional block based on a set of design considerations; generating a parallel functional pattern for testing the functional block; and translating the parallel functional pattern into a serial pattern; compiling information for use in software translation of the parallel functional pattern into a serial pattern.

In general, in accordance with one or more embodiments, the present invention involves an apparatus for transforming a stand-alone verification test for a functional block into a serial scan test pattern for detecting manufacturing defects, comprising a functional block designed based on a set of design considerations and comprising a scan boundary, the scan boundary comprising a scan in chain and a scan out chain, a parallel functional pattern for testing the functional block; and software for translating the parallel functional pattern into a serial pattern that is fed into the scan in chain, evaluated, and fed out of the scan out chain.

Other aspects and advantages of the invention will be apparent from the following description and the appended claims.

### BRIEF DESCRIPTION OF THE DRAWINGS

FIG. 1 shows an exemplary configuration of defining architectural units blocks in a circuit under test in accordance with an embodiment of the present invention.

FIG. 2 shows an exemplary configuration of defining functional blocks in an architectural unit in accordance with an embodiment of the present invention.

FIG. 3 shows a 1-bit state element in accordance with an embodiment of the present invention.

FIG. 4 shows a 1-bit scannable state element in accordance with an embodiment of the present invention.

FIG. 5 shows an exemplary configuration of a sequential path for shifting test patterns into and out of a functional block in accordance with an embodiment of the present invention.

FIG. 6 shows an exemplary scan chain with n input signals and in outputs in a functional block in accordance with an embodiment of the present invention.

FIG. 7 shows an exemplary configuration of unbalanced paths in a functional block in accordance with an embodiment of the present invention.

FIG. 8 shows an exemplary configuration of multiple paths in a functional block in accordance with an embodiment of the present invention.

FIG. 9 shows an exemplary configuration of protecting information in an array in accordance with an embodiment of the present invention.

FIG. 10 shows an exemplary configuration of protecting information in a non-scan state element in accordance with an embodiment of the present invention.

FIG. 11 is a flow char t describing a block-level IC test design in accordance with an embodiment of the present invention.

### DETAILED DESCRIPTION

In one aspect, the present invention involves methodologies for IC test de sign. By implementing guidelines during IC design and taking those into consideration during test design, IC tests can be created to effectively handle blocks not well covered by traditional DFT techniques.

Designers of individual blocks have a wide range of functional patterns for verifying the functionality their specific block. Also, the designers have detailed knowledge of the blocks and thus, can craft high quality tests for the blocks either from the functional verification point of view or from the manufacturing test coverage point of view. If these block level, stand-alone patterns can be applied at the chip level, the problem of full-chip test pattern generation is reduced to block level pattern generation. As a part of the overall DFT methodology, the chip already has a scan mechanism in place and embodiments of the present invention make use of that fact.

In accordance with one or more embodiments of the present invention, the scan chain mechanism is used to apply block level parallel patterns serially at the chip level. In order to do this, specific design guidelines need to be adhered to by block designers and the global DFT methodology needs to be tailored to accommodate testing of these blocks in this manner.

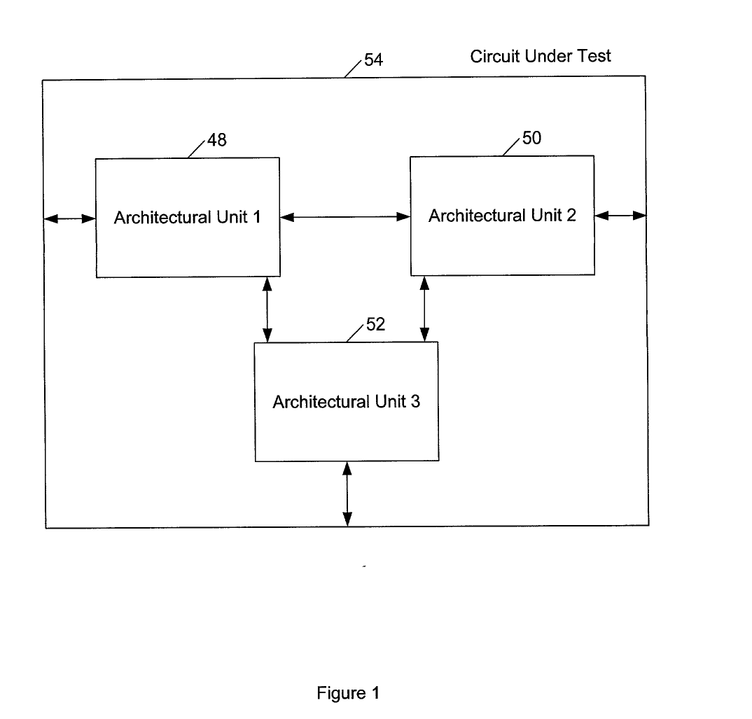

Referring to FIG. 1, in accordance with an embodiment of the present invention, an IC test may be designed at the functional block level of integrated circuits. First, test process begins with defining scan boundary of architectural units in a circuit under test (CUT). For example, Architectural Unit 1 (48), Architectural Unit 2 (50), and Architectural Unit 3 (52), may be defined as shown. These architectural units are any functional block at the architecture level of the CUT (54), e.g., the instruction schedule unit (ISU) in a microprocessor may be identified as an architectural unit that manages the execution order of instructions when the microprocessor is tested.

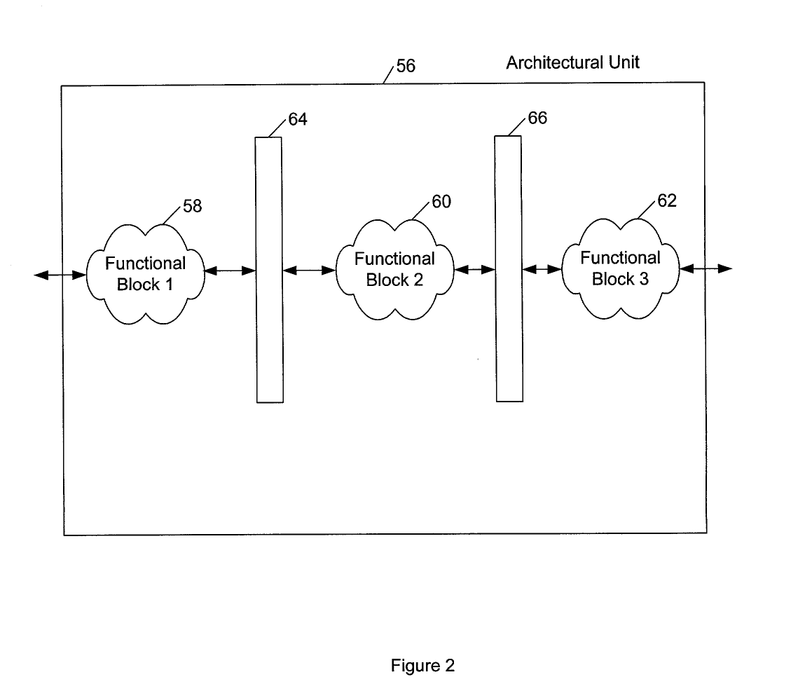

In applying the methodology in accordance with one or more embodiments of the present invention, a functional block with a scan boundary needs to be defined corresponding to each architectural unit. For example, referring to FIG. 2, the three functional blocks (58, 60, and 62) may be defined in Architectural Unit (56). Each functional block is a group of elements implementing logic operations. The block may be combinational logic, sequential logic, memory arrays, registers, or any other logic blocks.

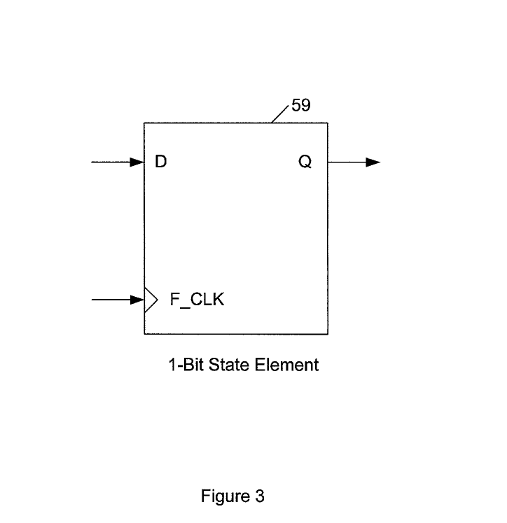

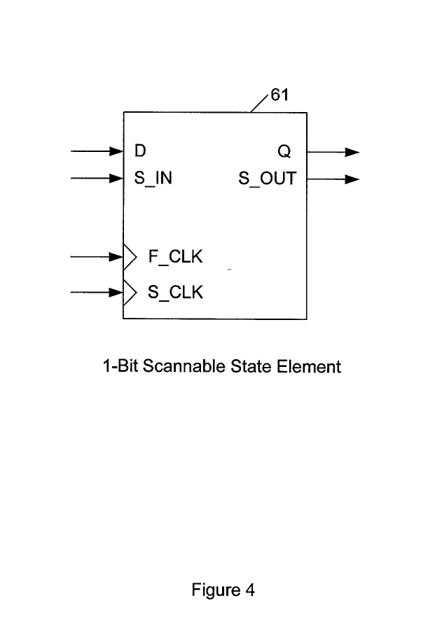

In the functional block (56), state elements (64, 66) may be also identified. An exemplary state element is a D-flip flop. As those skilled in the art will appreciate, a D-flip flop sends a received input (D) to its output (Q) based on the control of the clock (f_clk). FIG. 3 shows a 1-bit state element (59). FIG. 4 shows a 1-bit scannable state element (61). In a scannable state element, an additional input (s_in), output (s_out), and control clock (s_clk) are included for the purpose of scanning bits into and out of the state element. Ideally, the functional blocks should have scannable state elements at all functional inputs and outputs.

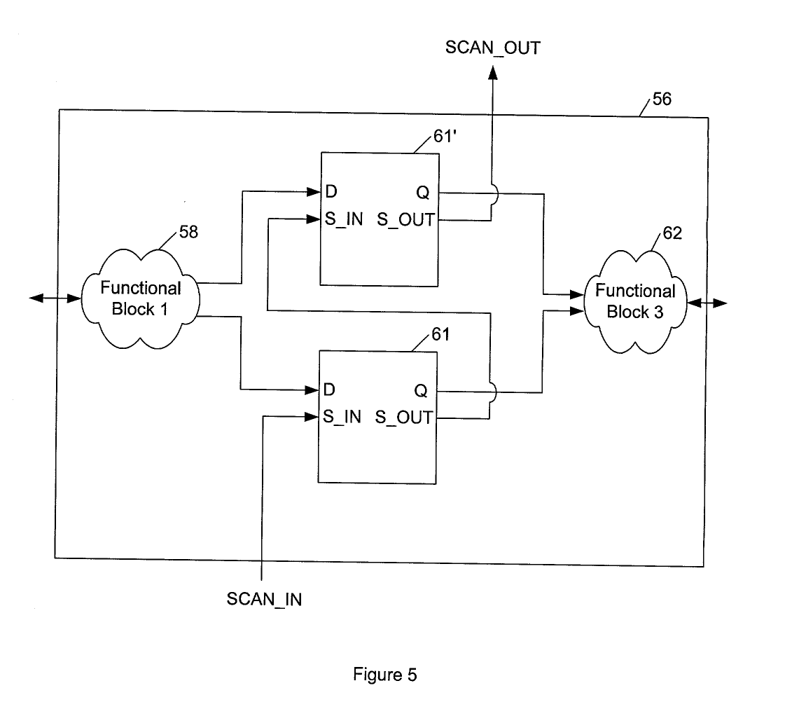

The state elements are selectively linked to generate at least one sequential path used for shifting test patterns into and out of the functional block (56). For example, scannable state elements (61, 61 ), as shown in FIG. 4, may be linked to create a sequential path as shown in FIG. 5. The sequential path leads from the SCAN_IN terminal to the SCAN_OUT terminal through the state elements (61,61′).

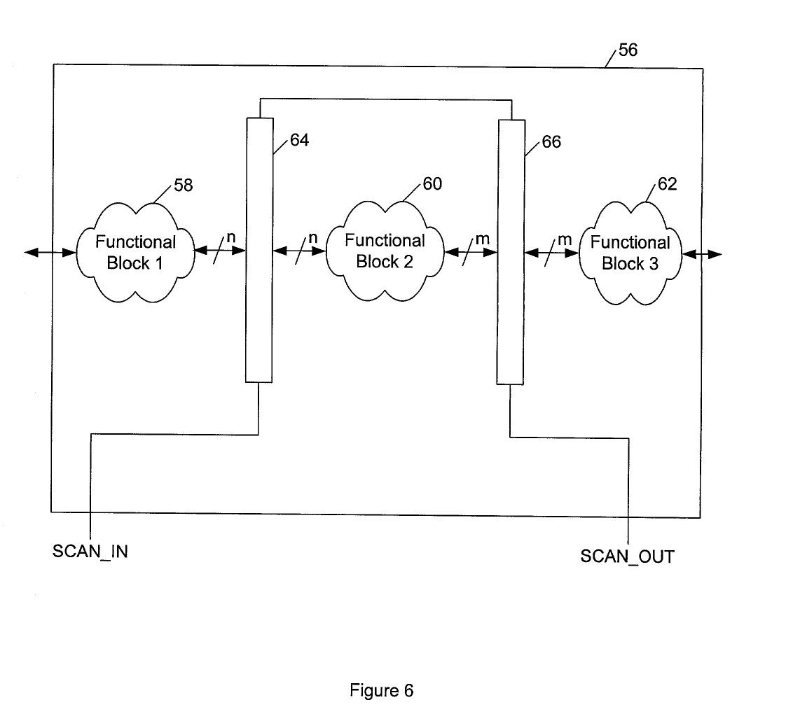

As shown in FIG. 6, a typical block will have n input signals and m output signals with each of these signals being flopped in scannable state elements and with no sequential state elements in between. A set of p parallel patterns, i.e., p pairs of n-bit stimulus and corresponding m-bit response of the block to that stimulus, is used to test the block. In this methodology, each of the p patterns is converted to a sequence of n scan shifts where each stimulus bit is shifted in one scan clock cycle at a time. During this scanning, there is no functional evaluation of the logic in the block. Once the n-bit stimulus is completely shifted in, it is functionally evaluated and the m-bit response is captured in the scannable output state elements. Then, again using the scan clock, the m bits of response are scanned out, one every scan cycle and compared to the expected response. This is repeated for each of the p patterns. Because the scan chain is hooked to the IC pins, a block embedded deep inside the IC can be accessed for test purposes.

Table 1 below shows the general form for a stand alone verification test.

TABLE 1
Stand Alone Verification Test

| | Functional Clock | | |
|---|---|---|---|
| Pattern | Cycle | Parallel Input | Parallel Output |
| 1 | 1 | (x₁¹, x₂¹, . . ., xₙ¹) | (y₁¹, y₂¹, . . . yₘ¹) |
| 2 | 2 | (x₁², x₂², . . ., xₙ²) | (y₂¹, y₂², . . ., yₘ²) |
| . . . | . . . | . . . | . . . |
| p | p | (x₁^{p}, x₂^{p}, . . ., xₙ^{p}) | (y₁^{p}, y₂^{p}, . . ., yₘ^{p}) |

Table 2 below shows a serialized scan based test using the pattern shown above in Table 1. The process shown would be repeated p times for p number of patterns.

TABLE 2
Serialized scan based test

| | | Clock Cycle | Scan In | Scan Out | | |
|---|---|---|---|---|---|---|
| | | 1 | (x₁¹) | — | | |
| n cycles | | 2 | (x₂¹) | — | | |
| | {open oversize brace} | | | | | |
| scan | | . . . | . . . | . . . | | |
| | | n | (xₙ¹) | — | | |
| func. clock | | n + 1 | — | — | {close oversize brace} | Pattern |
| | | n + 2 | — | (y₁¹) | | |
| m cycles | | n + 3 | — | (y₂¹) | | |
| | {open oversize brace} | | | | | |
| scan | | . . . | . . . | . . . | | |
| | | n + m + 1 | — | (yₘ¹) | | |

A sequential path is defined as a path with a state element on it. In one or more embodiments, the disclosed methodology targets blocks that have scannable inputs and outputs, but no scan inside the block. So, if a functional block has any state elements inside the scan boundary, those state elements would be non-scannable.

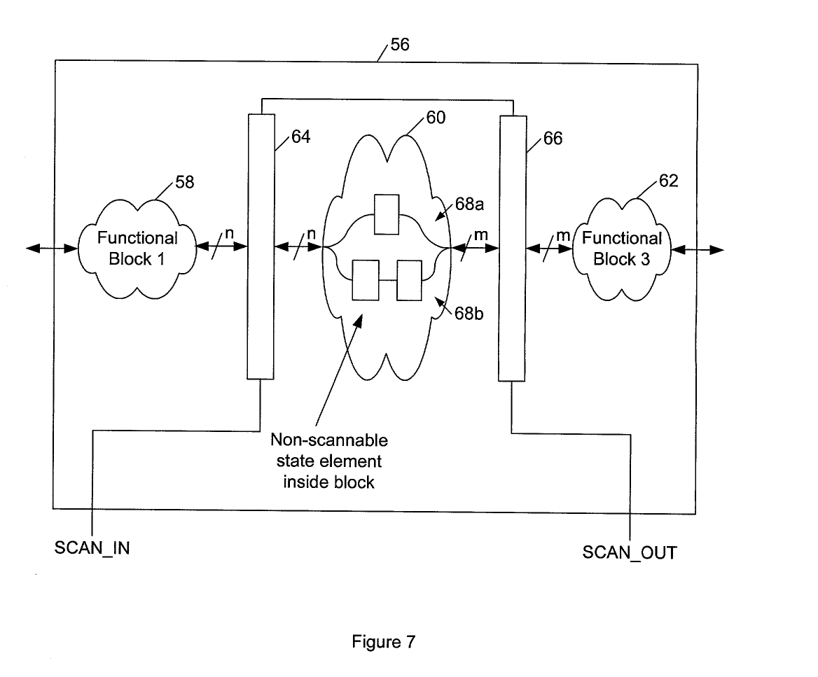

When sequential paths in a block are balanced, timing mismatches are avoided. However, as shown in FIG. 7, it is possible to design a block, such that it has sequential paths from an input scan state element to output scan state elements with different sequential depths, i.e., with different number of non-scannable elements on the paths.

In such a situation, a parallel input pattern loaded into the input scannable elements serially and then applied using the functional clock to the block does not produce a true representative evaluation of the block because of the different cycle lengths. Thus, the response captured is not the true representative evaluation of the block under functional conditions. In order to avoid this discrepancy, all paths should have the same sequential depth.

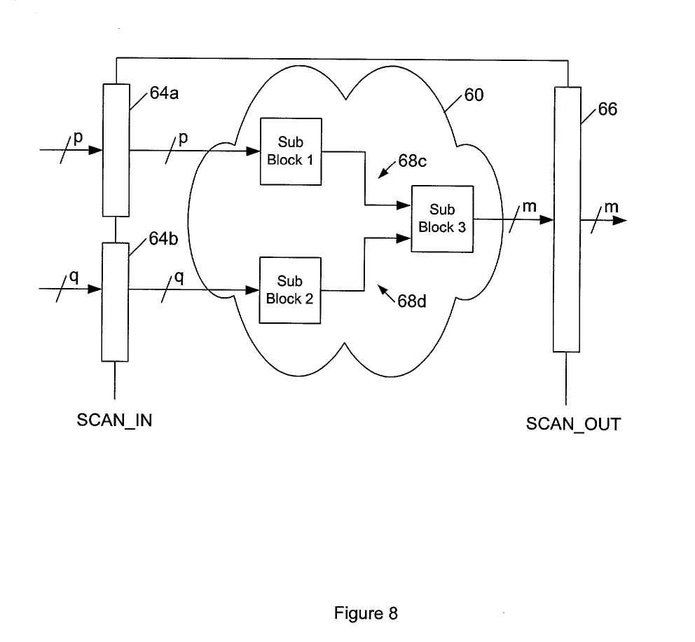

A functional block could comprise sub-blocks interacting in such a way that it is not possible to propagate faults in two sub-blocks simultaneously to an output scan state element. As shown in FIG. 8, sub-blocks 1, 2, and 3 form two distinct paths 68c and 68d for testing. In scenarios such as these, the sub-blocks have to be covered in separate test sessions. Each sub-block can be tested separately and during the testing of one sub-block, conditions are set to propagate the fault effects in that sub-block to the output scannable state elements. The conditions are set by constraining the scannable inputs of the sub-block that is not being tested in that particular test session. That is, to test sub-block 1, the input flops (64b) of sub-block 2 are set such that the output of sub-block 2 is fixed to a value that allows propagation of fault effects from input flops (64a) of sub-block 1 through sub-block 3 to the output flops (66).

There might be a need to create test control points to sensitize certain paths in the block so as to propagate faults to output scan state elements. The block will need to be designed with such test control signals by introducing a scan state element, where the scanned data in the state element provides the control value in the test mode and the normal functional input of the state element will provide the control value during normal operation. There are many different ways of doing this depending on the logic and circuit design under consideration. For example, multiplexers may be used for the test control points to select a mode between test and normal mode, to select a path among multiple test paths, etc.

In one or more embodiments of the present invention, each parallel functional pattern is transformed into a combination of serially shifting the stimulus into input scan elements, that stimulus is applied using functional clocks, and the captured response is shifted out. This sequence is repeated for each of the parallel patterns as described above. When applied in the functional mode, each the parallel patterns are applied one clock cycle after another. The same conditions need to be met when applying the pattern. The state of the functional block after application of one parallel pattern using the serial scan mechanism, needs to be maintained throughout the process of scanning out the response of the applied pattern and scan-in in the stimulus for the next parallel pattern.

If the scan clock and functional clock are derived from the same clock source, the state of the functional block during scanning in and out can be corrupted by the sequence of clock pulses applied for scanning. This is true of logic consisting of arrays or non-scan state elements. The state of the array and non-scan elements can be preserved through the use of a global test control signal. During scanning, this signal is asserted and it disables writes to arrays and holds data in non-scan state elements.

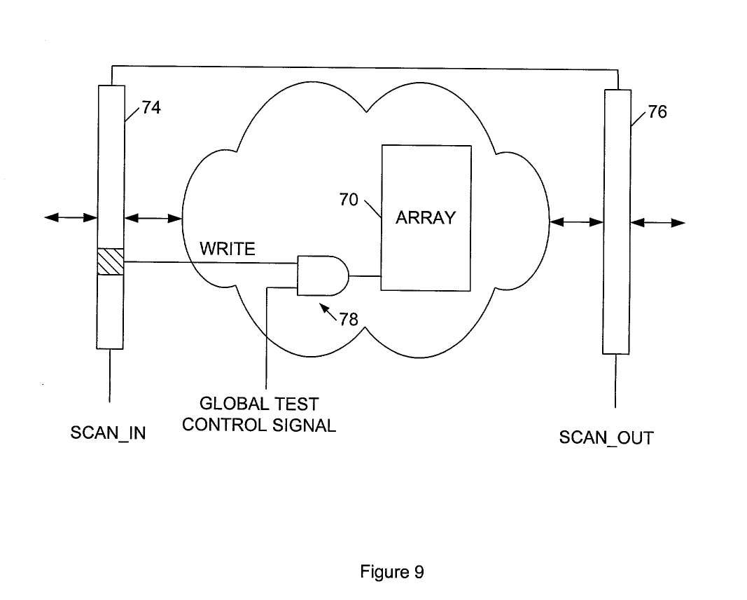

FIG. 9 shows a diagram of a functional block employing a global test control signal to protect the data in a memory array. In the embodiment shown, the WRITE signal feeds to the array (70) within a logic block 4 (72) located between scan-state elements (74, 76) through an AND gate (78) gate. The AND gate (78) also receives a global test control signal. During test mode, the global test control signal is set low for shifting test patterns. Consequently, the AND gate (78) has a constant low output. Thus, no information is written in the array (70) during the test mode. On the other hand, during normal mode, the global test control signal is set high for applying the test patterns. The AND gate (78) outputs high when WRITE signal is high at the state element (74). Thus, the information may be written in the array.

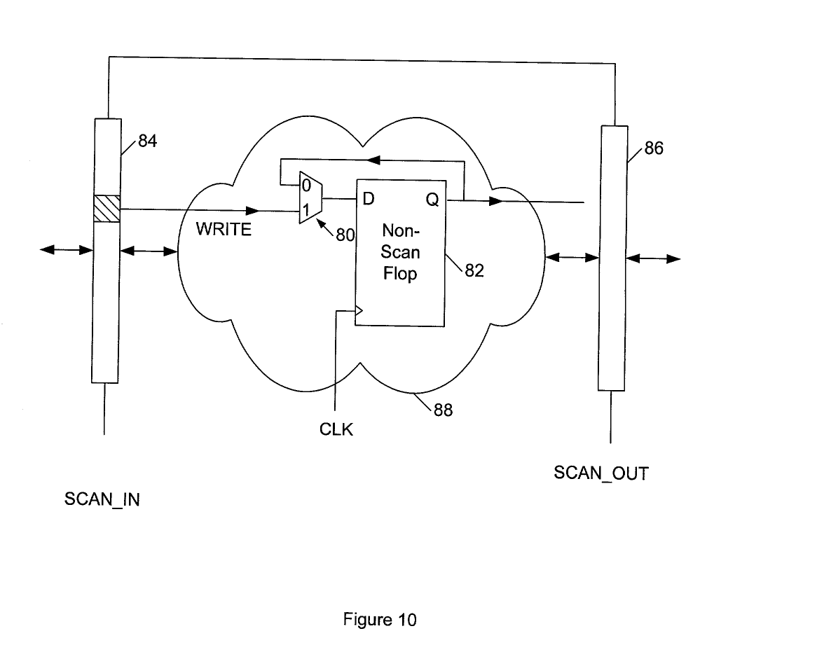

Referring to FIG. 10, in order to protect data in a non-scan state element (82) within a logic block (88) between scan-state elements (84, 86), a value needs to be held during shifting test patterns. To accomplish this, for example, a hold mode may be created using a multiplexer. The multiplexer (80) receives feedback from the output terminal (Q) of the non-scan D-flip flop (82) and also receives input from state element (84). The multiplexer (80) controls the signal transfer to the non-scan D flip-flop (82) using the select signal. The select signal is used to toggle between hold mode and normal mode. In hold mode, the value at the non-scan state element remains same due to the feedback loop created by the multiplexer. During normal mode, test patterns can be loaded into the non-scan state element through via the WRITE signal.

While testing a block, other blocks with scan boundaries need to be protected. Two ways of accomplishing this are, for example, (1) to separate the scan chains of various functional block at the chip-level and activate only the scan chain of functional blocks that are being tested, and (2) to have one scan chain for all blocks, but use global control signals to deactivate the functional evaluation of block that are not being tested.

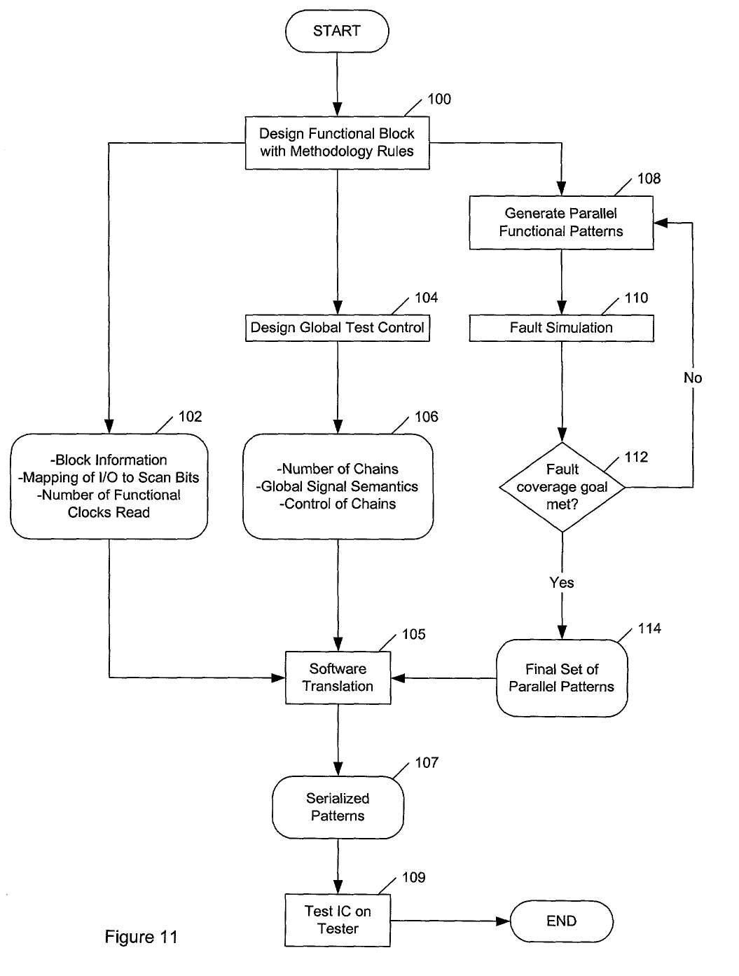

Referring back to FIG. 11, a process in accordance with an embodiment of the present invention is shown. In the flowchart shown, square-edged rectangles represent processes or tool, and rounded-edged rectangles represent information files. First, functional blocks are designed in accordance with the rules set forth above (step 100).

Then, for each functional block defined, block information, the mapping of I/O to scan bits, and the number of functional clock cycles needed for reading are collected (step 102). This information relates to the block-level design considerations discussed above, e.g., inclusion of scan boundaries, balancing of sequential paths, coverage of sub-blocks in separate test sessions, insertion of test control signals, and protecting data in arrays in non-scan state elements.

Also, for each block, a global test control is designed (step 104). Chip-level test control signals are used to ensure the methodology works properly. Chip-level global control signals are usually generated by a test control block on a chip. The block could use either an IEEE1149.1 Std compliant Test Access Port (TAP) mechanism or a custom design of the test mechanism. The global test control is designed in view of the global test control design considerations discussed above, e.g., inclusion of multiple functional evaluation clocks, prevention of corruption of data in block during shifting, and prevention of corruption of data in other blocks during test.

Thereafter, information relating to the number of chains, global signal semantics, and control of chains is collected (step 106). This information relates to the global test control considerations discussed above, e.g., evaluation of multiple functional clocks, prevention of corruption of data in blocks during shifting, and prevention of corruption of data in other blocks during testing.

Additionally, parallel functional patterns are generated (step 108) and fault coverage analysis of the generated patterns is performed using a fault simulation tool (step 110). If the patterns are able to meet the fault coverage goal (step 112), a final set of parallel patterns is collected (step 114). Otherwise, the patterns are re-designed to fill the coverage gaps identified (step 108).

Once all the information regarding the functional block is collected (steps 102, 106, 114), the parallel block-level patterns need to be converted to serial patterns at the chip-level. Translation software can be used to translate the block-level parallel patterns to serial format for application through the scan chain. The translation software receives the following informational inputs:

(1) Length of scan chain, if one chain is used to test multiple blocks. If each block has a separate chain, then the mapping of chain to the block will be the input;

(2) The permutation of bits in the chain and the mapping of scan bits to input and output signals of the block;

(3) The number of functional evaluation clocks required for the block;

(4) Semantics of global test control signals; and

(5) Scan chain control sequence and signals.

Using this information, the translation software translates the parallel patterns into serialized chip-level patterns (step 105). Then, these serialized patterns are collected (step 107) for application to an IC on a tester (step 109).

Advantages of the present invention may include one or more of the following. Embodiments of the invention may be used for generating high fault coverage tests for certain blocks in an IC. More specifically, the embodiments may be used to improve the testing of portions in an IC that are otherwise not guarantee high fault coverage. For example, the fault coverage obtained by ATPG in a block with partial scan test may be improved. In the partial scan test, test patterns are typically prepared using sequential ATPG algorithm. In an embodiment of the invention, a number of available verification patterns may be able to be used by transforming the verification tests for embedded block into serial format test patterns. Thus, the accuracy of pattern generations in IC tests and, in turn, the performance of IC tests may be improved.

Similarly, embodiments of the invention may be applied to sequential paths that use multi-cycle paths, small arrays and register files that do not fall under the scope of BIST, memory shadow logic and special circuits such as scoreboards in microprocessors. The scoreboard is a group of registers that hold information relating to instruction executions. For each case listed above, a scan test may be generated by transforming verification patterns for embedded block in a circuit-under-test (CUT) into a sequence of bit patterns. Test patterns with improved fault coverage are achieved by transforming the verification tests for embedded block into serial format test patterns.

In one or more embodiments, the ability to issue multiple capture clocks in test mode may be provided, control signals to prevent corruption of data in a particular block during shifting patterns may be provided, and control signals to prevent corruption of data in other blocks when the particular block is being tested may be provided. In an embodiment of the invention, given the scan-able input and output boundary for a block, generation of high quality patterns can be accomplished by fault grading stand-alone verification patterns and by enhancing those patterns for fault coverage.

In individual block design of an IC, a wide range of functional patterns is available for verifying their specific blocks. Based on the detailed knowledge of the blocks, designers are able to craft high quality tests for the blocks either from the functional verification point of view or from the manufacturing test coverage point of view. Thus, chip level pattern generations can be reduced to block level pattern generations when the block level stand alone patterns are used for an IC test with scan mechanism.

In an embodiment of the invention, the infrastructure has the function of translating the block-level parallel patterns to serial format for applying through the scan chain. The translation integrates scan chain operation, filling in dummy scan bits in unused portion of the scan chain, setting appropriate global DFT signals, optimizing block test sessions, etc. along the parallel to serial translation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of transforming a stand-alone verification test for a functional block into a serial scan test pattern for detecting manufacturing defects, comprising:
designing a functional block based on a set of design considerations;
generating a parallel functional pattern for testing the functional block; and
translating the parallel functional pattern into a serial pattern.

2. The method of claim 1, further comprising:
designing global test control based on a set of global test control design considerations.

3. The method of claim 1, further comprising:
performing fault simulation on the generated parallel functional pattern to determine if the generated parallel functional pattern meets a fault coverage goal.

4. The method of claim 1, further comprising:
compiling information for use in software translation of the parallel functional pattern into a serial pattern.

5. The method of claim 1, the set of design considerations comprising:
inclusion of scan boundaries.

6. The method of claim 1, the set of design consideration comprising:
balancing of sequential paths.

7. The method of claim 1, the set of design considerations comprising:
coverage of sub-blocks in separate test sessions.

8. The method of claim 1, the set of design considerations comprising:
insertion of test control signals.

9. The method of claim 1, the set of design considerations comprising:
protecting data in arrays in non-scan state elements.

10. The method of claim 2, the set of global test control design considerations comprising:
including multiple functional evaluation clocks.

11. The method of claim 2, the set of global test control design considerations comprising:
preventing corruption of data in block during shifting.

12. The method of claim 2, the set of global test control design considerations comprising:
preventing corruption of data in other blocks during test.

13. The method of claim 4, the compiled information comprising:
length of scan chain.

14. The method of claim 13, the compiled information further comprising:
permutation of bits in the scan chain.

15. The method of claim 4, the compiled information comprising:
mapping of scan bits to input and output signals.

16. The method of claim 4, the compiled information comprising:
number of functional evaluation clocks required.

17. The method of claim 4, the compiled information comprising:
semantics of global test control signals.

18. The method of claim 4, the compiled information comprising:
scan chain control sequence and signals.

19. A method of transforming a stand-alone verification test for a functional block into a serial scan test pattern for detecting manufacturing defects, comprising:
designing a functional block based on a set of design considerations;
generating a parallel functional pattern for testing the functional block; and
translating the parallel functional pattern into a serial pattern;
compiling information for use in software translation of the parallel functional pattern into a serial pattern.

20. The method of claim 19, the set of design considerations comprising:
inclusion of scan boundaries;
balancing of sequential paths;
coverage of sub-blocks in separate test sessions;
insertion of test control signals; and
protecting data in arrays in non-scan state elements.

21. The method of claim 19, the set of global test control design considerations comprising:
including multiple functional evaluation clocks;
preventing corruption of data in block during shifting; and
preventing corruption of data in other blocks during test.

22. The method of claim 19, the compiled information comprising:
length of scan chain;
permutation of bits in the scan chain;
mapping of scan bits to input and output signals;
number of functional evaluation clocks required;
semantics of global test control signals; and
scan chain control sequence and signals.

23. The method of claim 19, further comprising:
performing fault simulation on the generated parallel functional pattern to determine if the generated parallel functional pattern meets a fault coverage goal.

24. An apparatus for transforming a stand-alone verification test for a functional block into a serial scan test pattern for detecting manufacturing defects, comprising:
a functional block designed based on a set of design considerations and comprising a scan boundary,
the scan boundary comprising a scan in chain and a scan out chain,
a parallel functional pattern for testing the functional block; and
software for translating the parallel functional pattern into a serial pattern that is fed into the scan in chain, evaluated, and fed out of the scan out chain.

25. The apparatus of claim 24, the set of design considerations comprising:
inclusion of scan boundaries;
balancing of sequential paths;
coverage of sub-blocks in separate test sessions;
insertion of test control signals; and
protecting data in arrays in non-scan state elements.

26. The apparatus of claim 24, the set of global test control design considerations comprising:
including multiple functional evaluation clocks;
preventing corruption of data in block during shifting; and
preventing corruption of data in other blocks during test.

27. The apparatus of claim 24, further comprising:
a set of information for use in software translation of the parallel functional pattern into a serial pattern, the set of information comprising:
length of scan chain;
permutation of bits in the scan chain;
mapping of scan bits to input and output signals;
number of functional evaluation clocks required;
semantics of global test control signals; and
scan chain control sequence and signals.

28. The apparatus of claim 24, further comprising:
a fault simulation means for determining whether the generated parallel functional pattern meets a fault coverage goal.
